(19) United States
(12) Patent Application Publication
(10) Pub. No.: US 2018/0081038 A1
(43) Pub. Date: Mar. 22, 2018

(54) Methods Circuits Devices Assemblies Systems and Functionally Associated Machine Executable Code for Light Detection and Ranging Based Scanning

(71) Applicant: INNOVIZ TECHNOLOGIES LTD., Kfar Saba (IL)

(72) Inventors: Moshe Medina, Haifa (IL); Smadar David, Qiryat Ono (IL); Julian Vlaiko, Kfar Saba (IL); David Elooz, Kfar Haroeh (IL); Yair Antman, Petach Tikva (IL); Oren Buskila, Hod Hasharon (IL)

(21) Appl. No.: 15/393,593

(22) Filed: Dec. 29, 2016

Related U.S. Application Data
(60) Provisional application No. 62/397,379, filed on Sep. 21, 2016.

(51) Int. Cl. G01S 7/481; G01S 17/08

(52) U.S. Cl. CPC G01S 7/4817; G01S 17/08

(57) ABSTRACT

Disclosed is a light detection and ranging (Lidar) device including a photonic pulse emitter assembly including one or more photonic emitters to generate and focus a photonic inspection pulse towards a photonic transmission (TX) path of the Lidar device, a photonic detection assembly including one or more photo sensors to receive and sense photons of a reflected photonic inspection pulses received through a receive (RX) path of the device, a photonic steering assembly located along both the TX and the RX paths and including a Complex Reflector (CR) made of an array of steerable reflectors, where a first set of steerable reflectors are part of the TX path and a second set of steerable reflectors are part of the RX path.

### RELATED APPLICATIONS

The present application claims priority from U.S. Provisional Patent Application No. 62/397,379, entitled: “Array of piezoelectric MEMS mirrors for Lidar applications”, filed on Sep. 21, 2016 which is hereby incorporated by reference into the present application in its entirety

### FIELD OF THE INVENTION

The present invention relates generally to the field of light detection and ranging. More specifically, the present invention relates to a Lidar with a photonic steering assembly.

### BACKGROUND

Lidar which may also be called “LADAR” is a surveying method that measures a distance to a target by illuminating that target with a laser light. Lidar is sometimes considered an acronym of “Light Detection and Ranging”, or a portmanteau of light and radar. Lidar may be used with terrestrial, airborne, and mobile applications.

Autonomous Vehicle Systems are directed to vehicle level autonomous systems involving a Lidar system. An autonomous vehicle system stands for any vehicle integrating partial or full autonomous capabilities.

Autonomous or semi-autonomous vehicles are vehicles (such as motorcycles, cars, buses, trucks and more) that at least partially control a vehicle without human input. The autonomous vehicles, sense their environment and navigate to a destination input by a user/driver.

Unmanned aerial vehicles, which may be referred to as drones are aircrafts without a human on board may also utilize Lidar systems. Optionally, the drones may be manned/controlled autonomously or by a remote human operator.

Autonomous vehicles and drones may use Lidar technology in their systems to aid in detecting and scanning a scene/the area in which the vehicle and/or drones are operating in.

Lidar systems, drones and autonomous (or semi-autonomous) vehicles are currently expensive and non-reliable, unsuitable for a mass market where reliability and dependence are a concern—such as the automotive market.

Host Systems are directed to generic host-level and system-level configurations and operations involving a Lidar system. A host system stands for any computing environment that interfaces with the Lidar, be it a vehicle system or testing/qualification environment. Such computing environment includes any device, PC, server, cloud or a combination of one or more of these. This category also covers, as a further example, interfaces to external devices such as camera and car ego motion data (acceleration, steering wheel deflection, reverse drive, etc.). It also covers the multitude of interfaces that a Lidar may interface with the host system, such as a CAN bus.

### SUMMARY OF THE INVENTION

The present invention includes methods circuits devices assemblies systems and functionally associated machine executable code for Lidar based scanning.

According to some embodiments of the present invention, a light detection and ranging (Lidar) device may include a photonic pulse emitter assembly including one or more photonic emitters to generate and focus a photonic inspection pulse towards a photonic transmission (TX) path of the Lidar device, a photonic detection assembly including one or more photo sensors to receive and sense photons of a reflected photonic inspection pulses received through a receive (RX) path of the device, a photonic steering assembly located along both the TX and the RX paths and including a Complex Reflector (CR) made of an array of steerable reflectors, where a first set of steerable reflectors are part of the TX path and a second set of steerable reflectors are part of the RX path.

According to some embodiments, the first set of steerable reflectors may direct a photonic inspection pulse from the photonic pulse emitter assembly towards a given segment of a scene to be inspected. Optionally, the second set of steerable reflectors may direct a photonic inspection pulse reflection, reflected off of a surface of an element present in the given segment of the scene, towards the photonic detection assembly. The array of steerable reflectors may be dynamic steerable reflectors. The dynamic steerable reflectors may have a controllable state, such as a transmission state, a reception state and/or an idle state. Also, the separate set of reflectors allocated to the RX path and to the TX path may achieve optical isolation between the TX and RX paths by spatial diversity and multiplexing.

According to some embodiment, the first set of steerable reflectors may be mechanically coupled to each other and the second set of steerable reflectors may be mechanically coupled to each other. The dynamic steerable reflectors are individually steerable. The first set of steerable reflectors may have a first phase and may be substantially synchronized and the second set of steerable reflectors may have a second phase and may be substantially synchronized. The first phase and the second phase may have a substantially fixed difference between them. The first set of steerable reflectors may oscillate together at a first frequency and the second set of steerable reflectors may oscillate together at a second frequency. The first and second frequency may have a substantially fixed phase shift between them. Optionally, increasing a number of dynamic steerable reflectors in a transmission state increases a transmission beam spread and/or decreasing a number of dynamic steerable reflectors in a reception state may decrease reception field of view (FOV) and may compensate for ambient light conditions.

According to some embodiments, dynamic steerable reflectors in an idle state may provide isolation between dynamic steerable reflectors in a transmission state and a reception state. A first set of steerable reflectors may be surrounded by a second set of steerable reflectors. A second set of steerable reflectors may be surrounded by a first set of steerable reflectors.

According to some embodiments, a method of scanning a scene may include: emitting a photonic pulse towards a photonic transmission (TX) path, receiving reflected photonic pulses received through a receive (RX) path, detecting with a detector a scene signal based on the reflected photonic inspection pulses, and complexly steering the photonic pulse towards a scene and the reflected photonic pulses from a scene to the detector, by reflecting at a first phase the photonic pulse and receiving at a second phase the reflected pulse, where the difference between the first and second phase may be dependent on the time it takes the photonic pulse to be reflected and return.

According to some embodiments, a vehicle may include: a scanning device to produce a detected scene signal, the scanning device including: a photonic pulse emitter assembly including one or more photonic emitters to generate and focus a photonic inspection pulse towards a photonic transmission (TX) path of the device, a photonic detection assembly including one or more photo sensors to receive and sense photons of a reflected photonic inspection pulses received through a receive (RX) path of the device, a photonic steering assembly located along both the TX and the RX paths and including a Complex Reflector (CR) made of an array of steerable reflectors, where a first set of steerable reflectors are part of the TX path and a second set of steerable reflectors are part of the RX path, and a host controller to receive the detected scene signal and control the host device at least partially based on the detected scene signal. Optionally, the host controller may be configured to relay a host signal to the scanning device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A shows an active scanning device which may include or be otherwise functionally associated with one or more photonic steering assemblies in accordance with some embodiments;

FIG. 1B is an example embodiment of the scanning device of FIG. 1A;

FIGS. 2A & 2B show a side view of a plurality of steerable reflector units in accordance with some embodiments;

FIG. 2C shows a block level diagram of a steerable reflector unit in accordance with some embodiments;

FIG. 3 shows an example complex reflector in accordance with some embodiments;

FIGS. 4A-4D show example steering devices in accordance with some embodiments;

FIGS. 5A-5C show example scanning device schematics in accordance with some embodiments;

FIG. 6 shows an example scanning system in accordance with some embodiments; and

FIG. 7 is a flow chart associated with a method of scanning a scene in accordance with some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention may include methods, circuits, devices, assemblies, systems and functionally associated machine executable code for Lidar based scanning. According to embodiments, there may be provided a scene scanning device adapted to inspect regions or segments of a scene using photonic pulses. The photonic pulses used to inspect the scene, also referred to as inspection pulses, may be generated and transmitted with characteristics which are dynamically selected as a function of various parameters relating to the scene to be scanned and/or relating to a state, location and/or trajectory of the device. Sensing and/or measuring of characteristics of inspection pulse reflections from scene elements illuminated with one or more inspection pulses, according to embodiments, may also be dynamic and may include a modulating optical elements on an optical receive path of the device.

According to some embodiments, inspection of a scene segment may include illumination of the scene segment or region with a pulse of photons, which pulse may have known parameters such as pulse duration, pulse angular dispersion, photon wavelength, instantaneous power, photon density at different distances from the emitter and/or average power. Inspection may also include detecting and characterizing various parameters of reflected inspection photons, which reflected inspection photons are inspection pulse photons reflected back towards the scanning device from an illuminated element present within the inspected scene segment (i.e. scene segment element). Parameters of reflected inspections photons may include photon time of flight (time from emission till detection), instantaneous power at and during return pulse detection, average power across entire return pulse and photon distribution/signal over return pulse period. According to further embodiments, by comparing parameters of a photonic inspection pulse with parameters of a corresponding reflected and detected photonic pulse, a distance and possibly a physical characteristic of one or more elements present in the inspected scene segment may be estimated. By repeating this process across multiple adjacent scene segments, optionally in some pattern such as a raster, Lissajous or snake bidirectional pattern, an entire segment scene may be scanned to produce a depth map of the scene segment.

The definition of a scene according to embodiments of the present invention may vary from embodiment to embodiment, depending on the specific intended application of the invention. For Lidar applications, optionally used with a motor vehicle platform, the term scene may be defined as the physical space, up to a certain distance, surrounding the vehicle (in-front, sides, above below and behind the vehicle). A scene segment or scene region according to embodiments may be defined by a set of angles in a polar coordinate system, for example, corresponding to a diverging pulse or beam of light in a given direction. The light beam/pulse may have a center radial vector in the given direction and may also be characterized by a broader defined by angular divergence values, polar coordinate ranges, of the light beam/pulse. Since the light beam/pulse produces an illumination area, or spot, of expanding size the further out from the light source the spot hits a target, a scene segment or region being inspected at any given time, with any given photonic pulse, may be of varying and expanding in size the farther away the illuminated scene segment elements are from the active scene scanning device. Accordingly, an inspection resolution of a scene segment may be reduced the farther away the illuminated scene segment elements are from the active scene scanning device.

A monostatic scanning Lidar system utilizes the same optical path for transmission (Tx) and reception (Rx) of the laser beam. The laser in the transmission path and appropriately the inspection photons emitted from the laser may be well collimated and can be focused into a narrow spot while the reflected photons in the reception path becomes a larger patch due to dispersion. Accordingly a steering device is required that is efficient for a large reflection photon patch in the reception path and the need for a beam splitter that redirects the received beam (the reflection photons) to the detector. The large patch of reflection photons requires a large microelectromechanical systems (MEMS) mirror that may have a negative impact on the FOV and frame rate performance. Accordingly, an array of reflective surfaces having a phase between the transmission and reception surfaces is shown. An array contains small mirrors that can perform at a high scan rate with larger angles of deflection. The mirror array may essentially act as a large mirror in terms of effective area. This method decouples the mirror design from the Tx and Rx path and also obsoletes the requirement for a beam splitter. Using the same photonic steering assembly may provide for tight synchronization between a direction in which a photonic pulse/beam is steered and emitted by the photonic emitter assembly and a direction of a concurrent FOV of one or more optical sensors of the photonic detection assembly. This shared photonic steering assembly configuration may allow for a photonic detector assembly of a given device to focus upon and almost exclusively collect/receive reflected photons from substantially the same scene segment being concurrently illuminated by the given device's photonic emitter assembly. Accordingly, as the photonic steering assembly moves, so does the photonic pulse illumination angle along with the FOV angle.

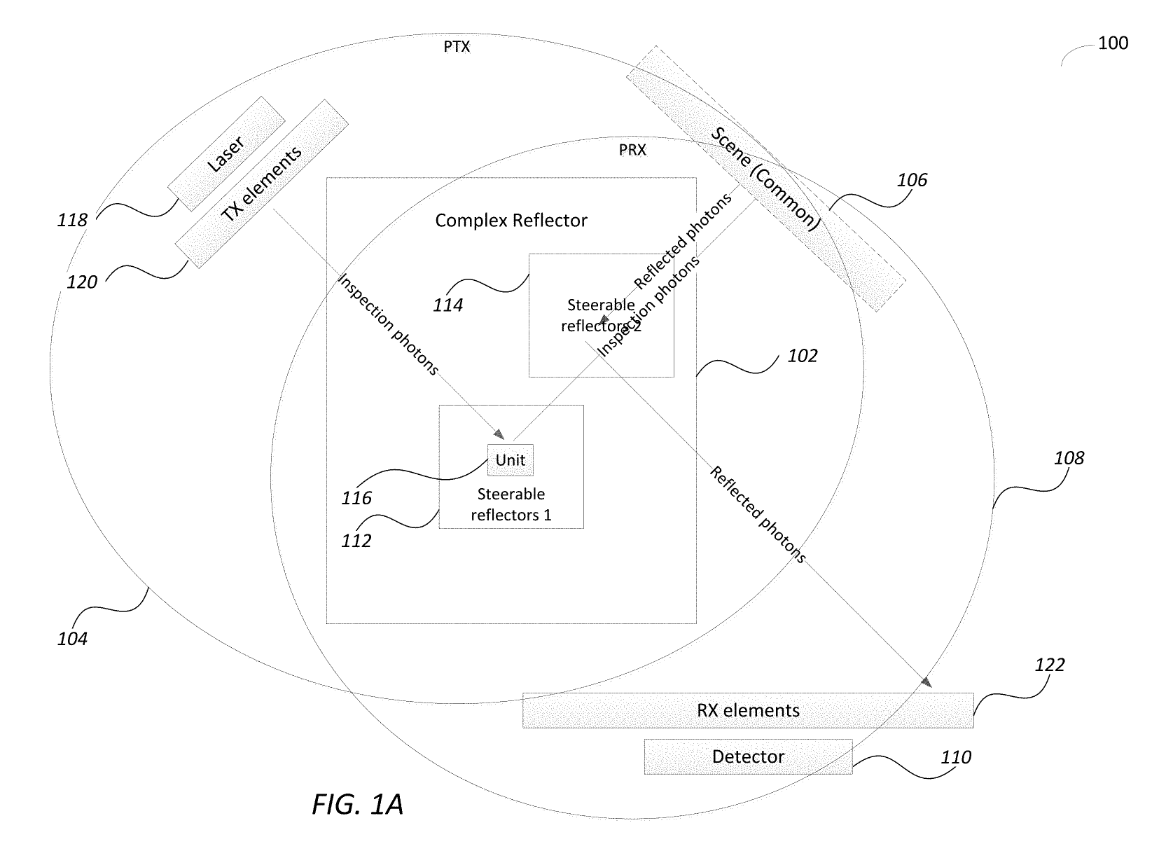

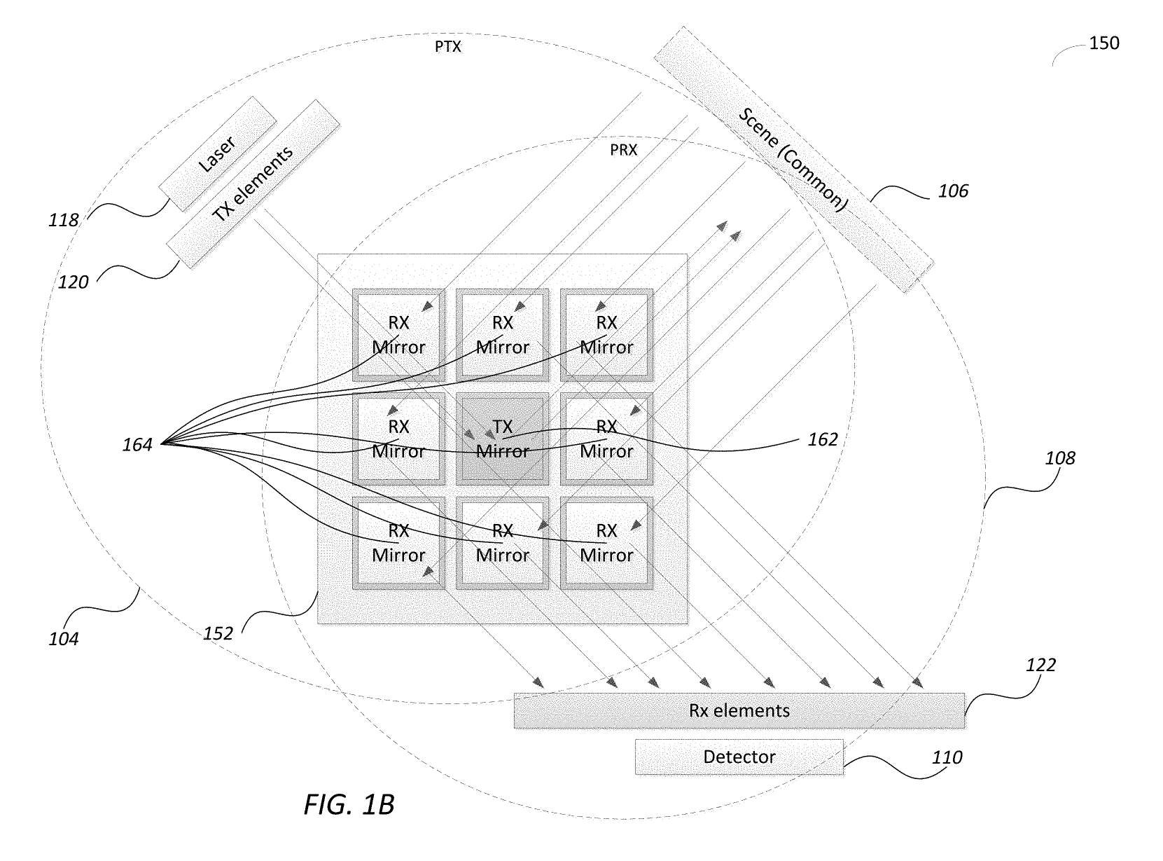

Turning to FIG. 1A, shown is an active scanning device 100 which may include or be otherwise functionally associated with one or more photonic steering assemblies such as complex reflector (CR) 102. CR 102 may be adapted to adjustably steer photons and/or a photonic pulse towards a selected direction, such as the direction of a center vector of a scene segment to be inspected. CR 102 may be part of a Photonic Transmission (PTX) path 104 of inspection photons emitted by the photonic emitter assembly and may direct, reflectively or using refraction, a pulse of inspection photons towards a scene segment to be inspected 106, (since the inspected scene segment is changing it is external to the scanning device and therefore has dashed line in the figure). CR 102, according to embodiments, may also be part of a photonic reception (PRX) path 108 for reflected inspection photons reflected from a surface of a scene element (object) present within an inspected/illumined scene segment 106, where CR 102 may direct reflected inspection photons, reflectively or using refraction, towards a photon detection aperture/opening of a photonic detector assembly such detector as 110.

According to embodiments CR 102 may include one or more sub-groups of steerable reflectors (SR) such SR1 112 and SR2 114. Each sub-group of electrically controllable/steerable reflectors may include one or more steerable reflector units such as unit 116. Unit 116 may include a microelectromechanical systems mirror or reflective surface assembly and/or an electromechanical actuator and more.

According to some embodiments, SR1 112 and/or SR2 114 may each include one or more units arranged next to one another in either a one or two dimensional matrix to form Complex Reflector 102. Unit 116 may be individually controllable, for example by a device controller and or a steering assembly controller, such that each reflector may be made to tilt towards a specific angle along each of one or two separate axis. A set of array reflectors, optionally reflectors adjacent to one another, may be grouped into a Common Control Reflector (CCR) set of array reflectors which are synchronously controlled with one another so as to concurrently tilt or point in approximately the same direction. According to some embodiments SR 1 112 and SR2 114 may each be comprised of one or more CCRs. Accordingly, CR 102 may be parsed into two or more CCR sets. SR1 112 and SR2 114 may each be in-line with, or part of, a separate optical path. As shown in this example SR1 112 may be part of PTX 104 while SR2 114 is part of PRX 108.

According to some embodiments, CR 102 may be configured to electrically steer one or more reflectors such as unit 116 to overcomes mechanical impairments and drifts due to thermal and gain effects or otherwise. For example, one or more units 116 may move differently than intended (frequency, rate, speed etc.) and their movement may be compensated for by electrically controlling the reflectors appropriately.

According to some embodiments, PTX 104 may be configured to produce pulses of inspection photons. PTX 606 may include a laser or alternative light source such as laser 118. Laser 118 may be a laser such as a solid state laser, a high power laser or otherwise or an alternative light source such as, a LED based light source or otherwise.

According to some embodiments PTX may include additional elements shown by TX elements 120 which may include a collimator, controller, feedback controller/signals and more.

According to some embodiments, PRX 108 may be configured to receive photons reflected back from an object or scene element of scene 106 and produce a detected scene signal. PRX 108 may include a detector such as detector 110. Detector 110 may be configured to detect the reflected photons reflected back from an object or scene element and produce a detected scene signal. PRX 108 may include additional elements shown in RX elements 122 which may include a module to position a singular scanned pixel window onto/in the direction of detector 110.

According to some embodiments, the detected scene signal may include information such as: time of flight which is indicative of the difference in time between the time a photon was emitted and detected after reflection from an object, reflected intensity, polarization values and more.

According to some embodiments, scanning device 100 may be a monostatic scanning system where PTX 104 and PRX 108 have a joint optical path for example, scene 106 may be a common path as well as CR 102 which, as described above, may be configured to direct pulses of inspection photons from PTX 606 in a direction of an inspected scene and to steer reflection photons from the scene back to PRX 608.

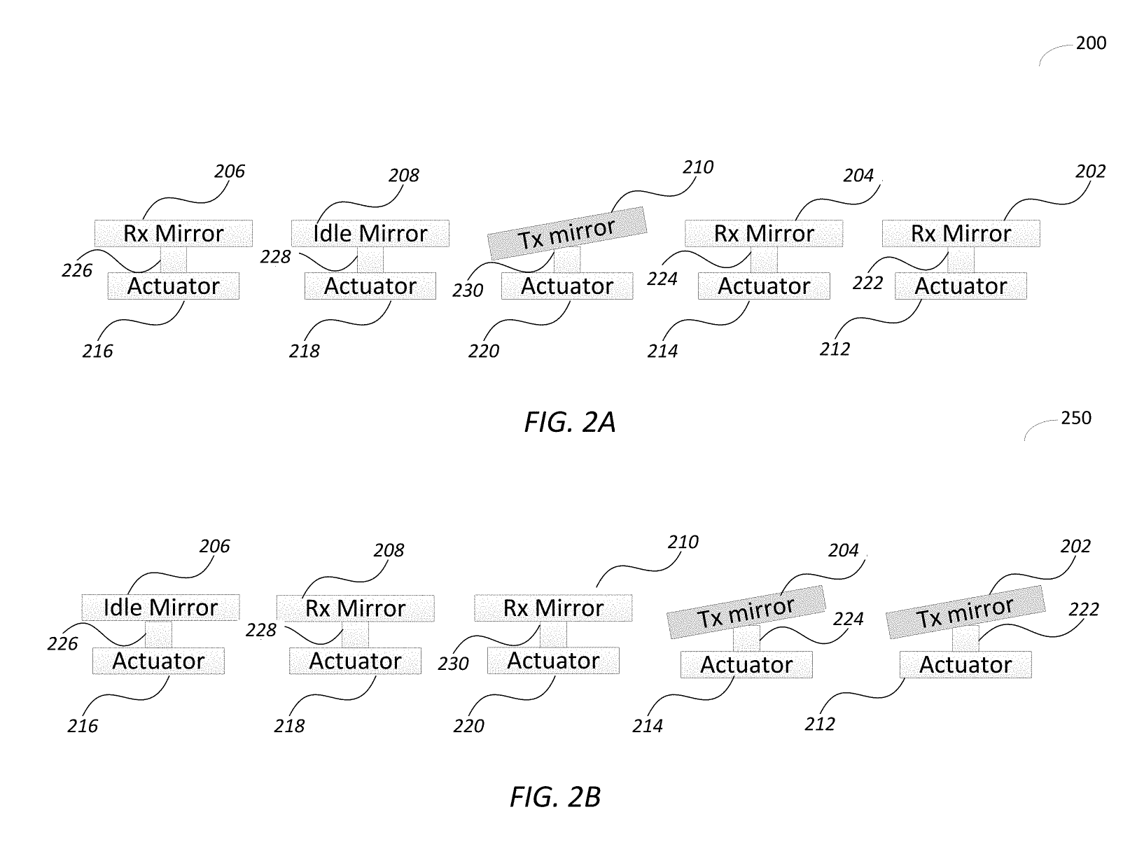

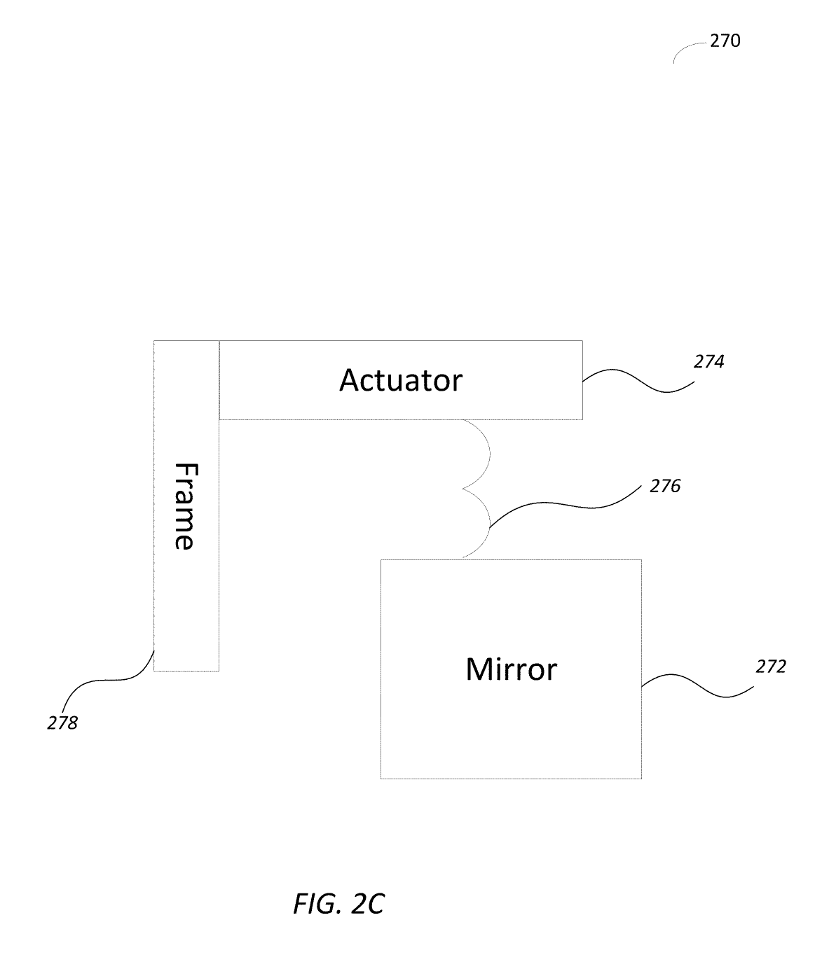

Turning to FIG. 2A, shown is a side view of a plurality of steerable reflector units 200, each unit may be substantially similar to unit 116 of FIG. 1. Each unit may include a reflective surface such as mirror 202, mirror 204, mirror 206, mirror 208 and mirror 210 associated with an actuator such as actuator 212, actuator 214, actuator 216, actuator 218, and actuator 220 (appropriately). Actuators 212-220 may alternatively be termed cantilevers or benders or actuators. Mirrors 202-210 may be any reflective surface, for example, made from polished gold, aluminum, silicon, silver, or otherwise. Mirrors 202-210 may be identical or different reflective surfaces varying in size and/or material. Actuators 212-220 may be electrically controllable electromechanical actuator such as a stepper motor, direct current motor, galvanometric actuator, electrostatic, magnetic or piezo elements or thermal based actuator or otherwise. Each actuator 212-220 may cause movement in a mirror support or spring such as segment 222-230.

According to some embodiments, each actuator 212-220 may be a separate actuator or may be a joined actuator for two or more mirrors, for example if actuator 216 and actuator 214 are a single actuator mirrors them mirrors 202 and 206 may move together. Alternatively, two or more actuators may be controlled to operate substantially in conjunction with each other. It is understood that a sub group of mirrors and actuators operating in unison or with a shared actuator may form a steerable reflector such as SR1 of FIG. 1 or that a single unit may be a steerable reflector in and of itself.

According to some embodiments, mirrors operating in a transmission path may have a first angle or a phase shift compared to mirrors operating in a reception path. The phase shift may remain constant across the entire scanning pattern or may exhibit a variation according to the angular position of both the mirrors in the PRX and PTX paths. Accordingly, in the example of FIG. 2A, mirrors 202, 204 and 206 are configured to be reception mirrors and are in a first angle while mirror 210 is in a second angle, and configured to be a transmission mirror. It is understood that some of the mirrors may be disabled and/or in an idle mode: (1) by being electrically or mechanically disabled for example by being denied the dynamic electrical signal that provides power to the actuator, the mirror may remain static in a certain position that does not contribute any signal to the scanned scene. It stays in a static location either by applying a certain voltage level or blocking the mirror by a mechanical means and/or (2) the mirror may point or scan an orthogonal direction with respect to the scene, out of the active FOV or (3) otherwise. Reflectors in an idle mode may serve as isolation between transmission and reception reflectors which may improve signal to noise ratio and overall signal detection/quality of signal (QoS).

According to some embodiments, mirrors which are in a transmission state, reception state and/or idle state may be dynamically controllable/selectable. Turning to FIG. 2B, shown is a side view of a plurality of steerable reflector units 250. Having the same mirrors 202-210 and actuators 212-220, except that in this instance mirrors 202 and 204 are configured to be transmission mirrors, mirrors 208 and 210 are configured to be reception mirrors and mirror 206 is an idle mirror.

Turning to FIG. 2C shown is a block level diagram of steerable reflector unit 270 which is substantially similar to unit 116 of FIG. 1A. Unit 270 may include a reflective surface such as mirror 272 and an actuator such as actuator 274. It is understood that mirror 272 is substantially similar to any of mirrors 202-210 and that actuator 274 is substantially similar to actuators 212-220 of FIGS. 2A&2B. Actuator 274 may be part of or attached at one end to a support frame such as frame 278. Actuator 274 may cause movement or power to be relayed to mirror 272. Actuator 274 may include a piezo-electric layer and a semiconductor layer and optionally, a support or base layer. Optionally, a flexible interconnect element or connector, such as spring 276, may be utilized to adjoin and relay movement from actuator 274 to mirror 272.

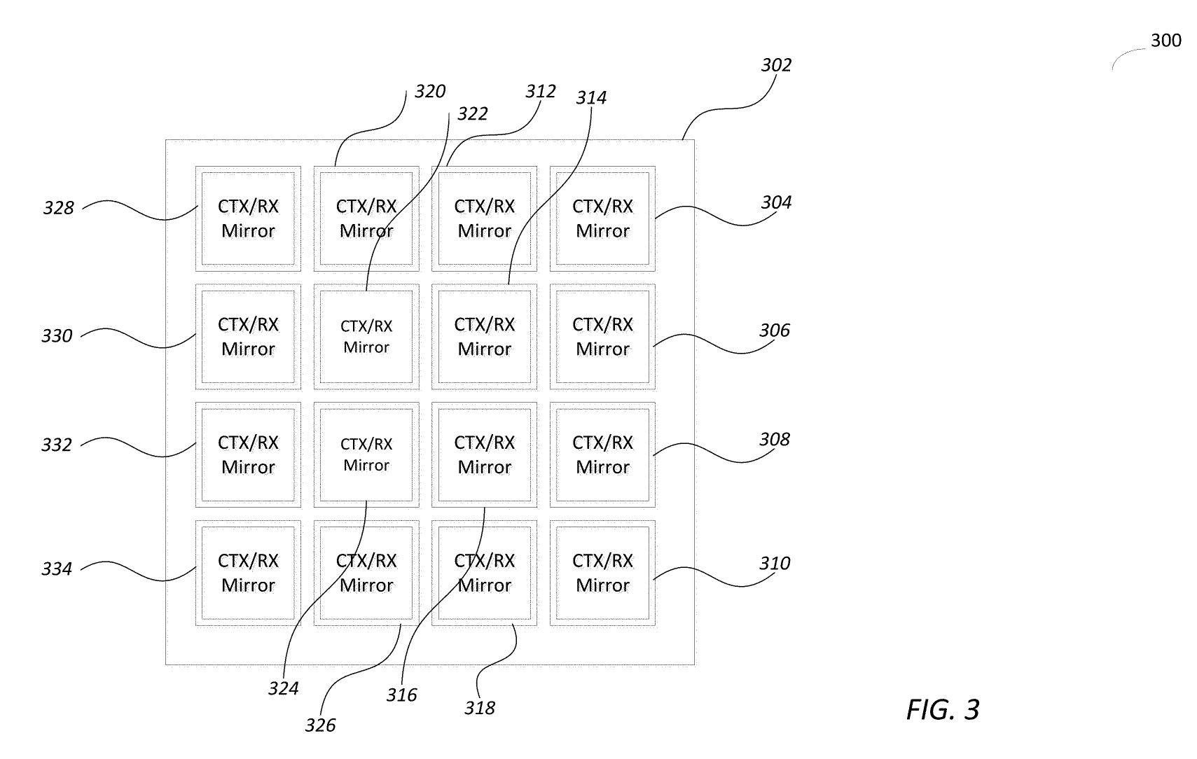

Turning to FIG. 3 shown is an example complex reflector such as CR 302. It is understood that CR 302 may serve as an example for CR 102 and that the discussion is applicable here as well. CR 302 may include a plurality of steerable reflector such as SRs 304-334. While a 4×4 matrix of SRs is shown it is understood that many dimensions of a matrix is applicable such as 1×2, 1×1, 1×4, 2×8 3×7 or otherwise.

According to some embodiments, SRs 304-334 may be dynamic SRs so that at each point of operating a scanning device which includes CR 302, each SR 304-334 may be controllably designated as either: (a) a complex reception reflector (CRXR) (in a reception state) included in the reception path and accordingly may steer reflected photons to a detector; (b) a complex transmission reflector (CTXR) (in a transmission state) included in the transmission path and may steer inspection photons in the direction of a scene or (c) an idle reflector (in an idle state). Accordingly, the same SR may be at times a CTXR and at other times a CRXR or an idle reflector.

According to some embodiments, SRs 304-334 may be static SRs so that they are each either a CRXR or a CTXR. A sub-set out of SRs 304-334 may operate in unison as a steerable reflector in a reception path and a different sub-set out of SRs 304-334 may operate in unison as a SR in a transmission path. The sub-sets may be mechanically, electrically and/or electro-mechanically coupled to each other.

According to some embodiments, a first set of SRs may operate in conjunction as a sub-set of CTXR which may operate in a first phase and a second sub-set of CRXR may operate in a second phase. The difference or delta between the first phase and second phase may be determined based on (or to compensate for) an expected difference between transmitted and received photons. The difference between the two phases may be fixed and/or synchronized. If CR 302 is moving in a predetermined controllable path to scan a scene then the location of CR when inspection photons is different than the location when the reflection photons are received so the difference in location can be compensated for by planning the second phase accordingly. Furthermore, the difference in phase is primarily utilized to separate the TX path from the RX path. The first and second subsets may oscillate at substantially the same frequency with differences due to mechanical inaccuracies or due to compensation for mechanical inaccuracies, mechanical impairments and/or drifts. Operation of the first and second sets of reflectors may be synchronized. For example, the reflectors of the first set and reflectors of the second set may be made to oscillate at substantially the same frequency. A phase shift between reflectors of the first set and reflectors of the second set may be substantially fixed and/or otherwise synchronized. The phase shift may vary in amplitude dynamically in order to compensate for the time delay between the transmitted photonic pulses and the received reflection. The purpose is to minimize the detector sensitive area by locating the reflected laser spot in the same place on the detector for the entire period of time of flight.

According to some embodiments, where SRs 304-334 are static SRs, a sub-set of SR's may be mechanically coupled so that they inherently operate in unison. The sub-set may include some or all of the SR's of the same path. Alternatively, each SR may be controlled separately and a sub-set of SRs may be controlled substantially in unison so that they operate substantially in unison, in such an example the different SRs may be electrically controlled/coupled together. Furthermore, a combination where part of a sub-group is mechanically coupled to each other is understood (for example, having a shared frame or cantilever).

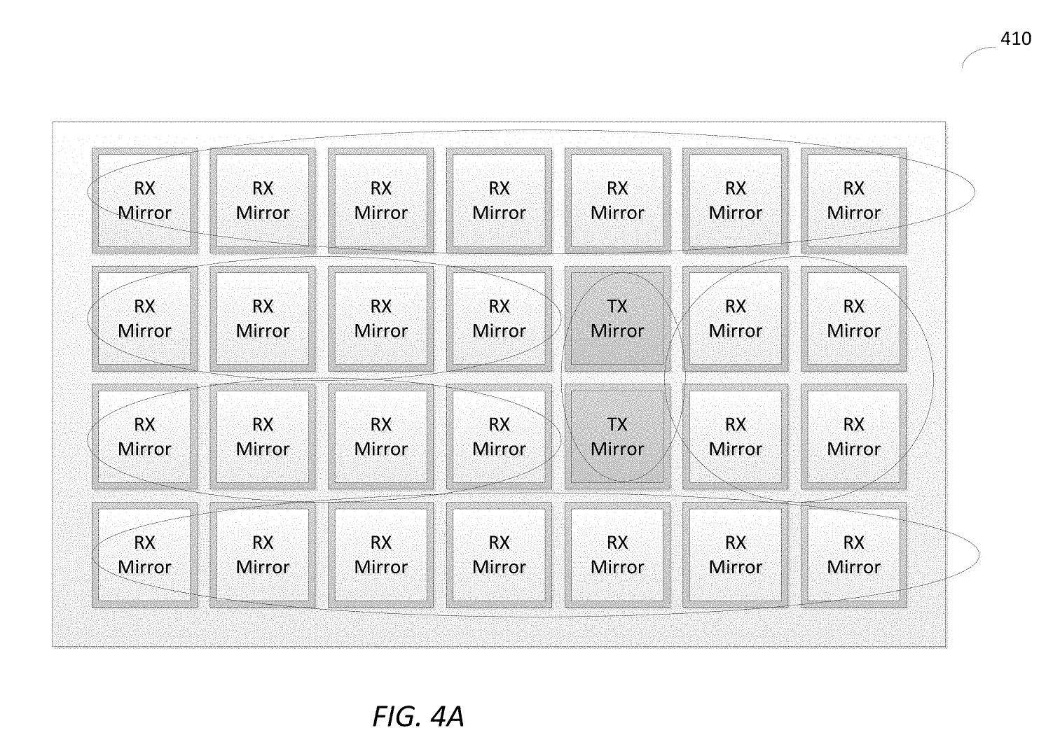

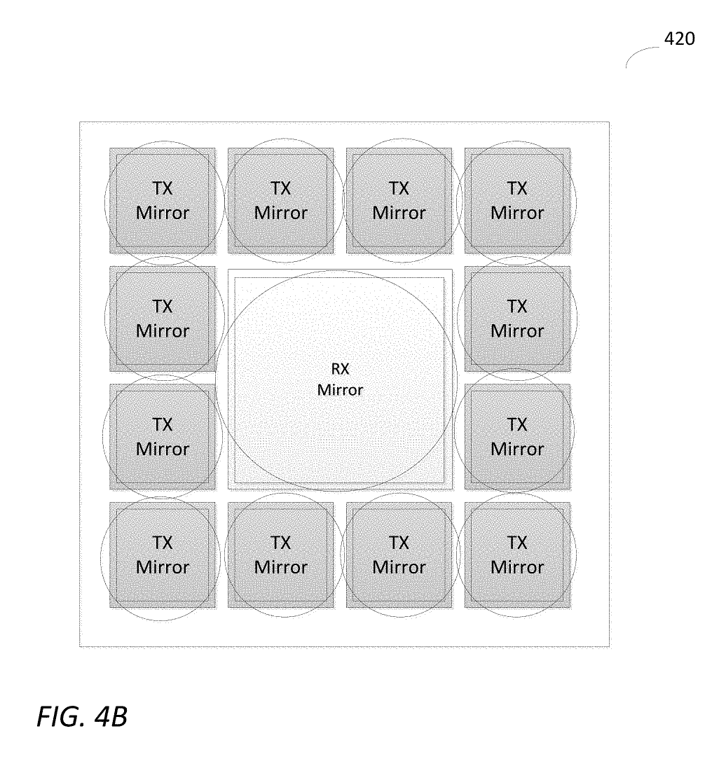

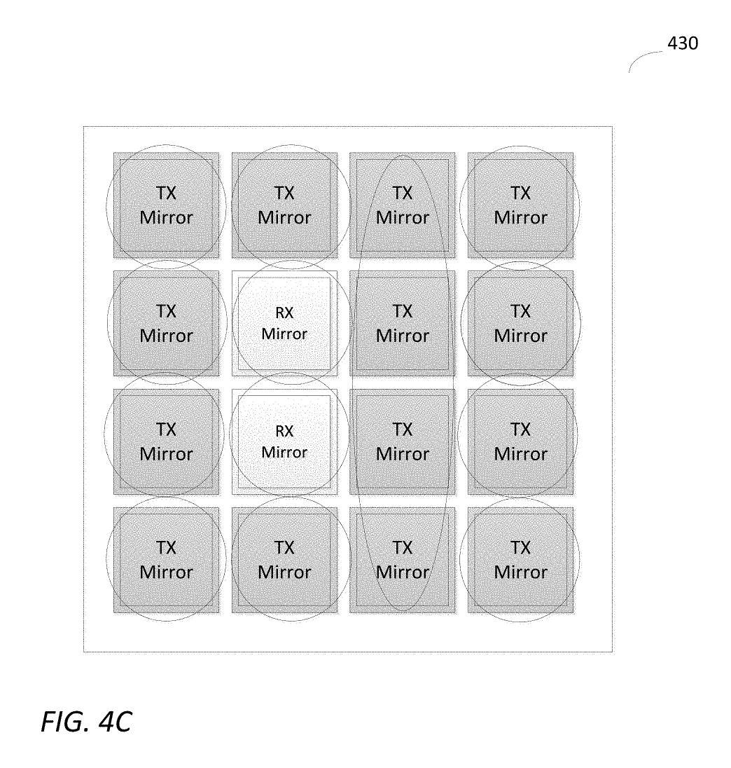

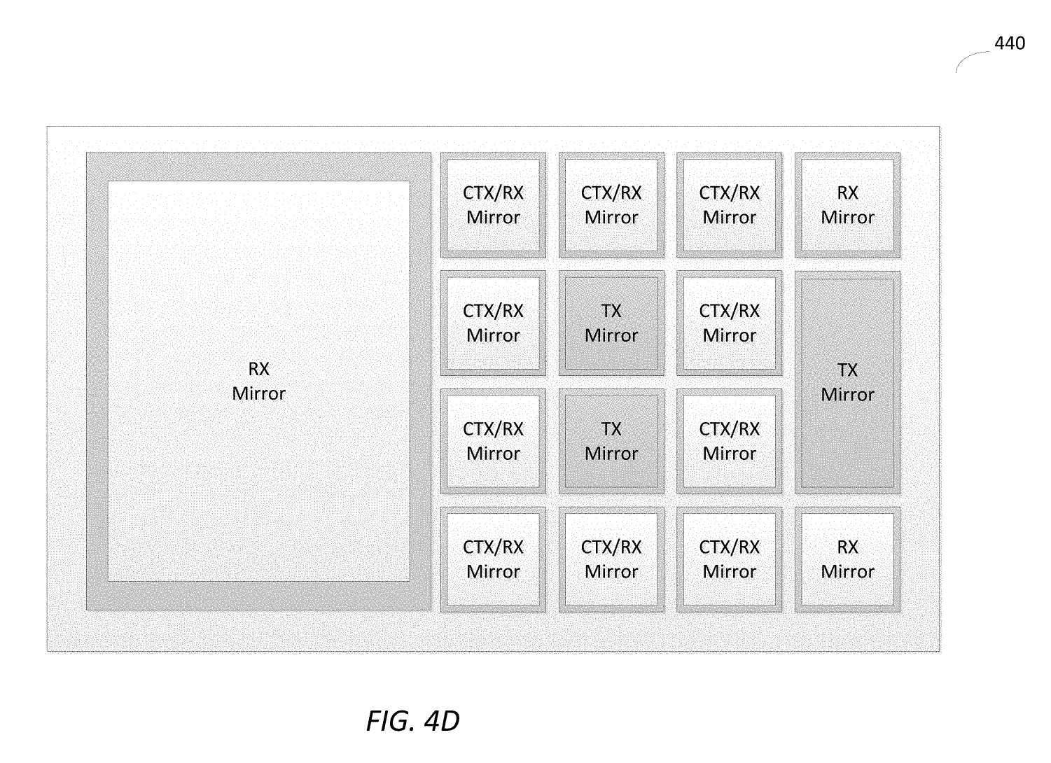

Turning to FIGS. 4A-4D shown are example steering devices. FIG. 4A depicts a non-symmetric steering device 410, with a plurality of static reception steerable reflectors and a couple of off-center static transmission steerable reflectors, in this example the steerable reflectors are all of a unison size. FIG. 4B depicts a symmetric steering device 420, with a single centered static reception steerable reflector of a first size and a plurality of static transmission steerable reflectors each of a second size. FIG. 4C depicts a non-symmetric steering device 430, with a plurality of static transmission steerable reflectors and a couple of off-center static reception steerable reflectors, in this example the steerable reflectors are all of a unison size. FIG. 4D depicts a non-symmetric steering device 440, with a plurality of static reception steerable reflectors of varying sizes, a plurality of static transmission steerable reflectors of varying sizes and a plurality of complex transmission reflectors which may each function as a transmission, reception or idle reflector.

According to some embodiments, increasing the amount of transmission Tx reflectors may increase a reflected photons beam spread. Decreasing the amount or reception Rx reflectors may narrow the reception field and compensate for ambient light conditions (such as clouds, rain, fog, extreme heat and more) and improve signal to noise ratio.

In FIGS. 4A-4C example reflectors which may be mechanically coupled are circled together. The four different examples are intended to show that any combination is applicable.

Turning to FIG. 1B, shown is an active scanning device 150 which may include or be otherwise functionally associated with one or more photonic steering assemblies such as complex reflector (CR) 152 which is meant to depict an example reflector embodiment. In this example, Tx reflector 162 is an example embodiment of SR1 112 of FIG. 1A having a single unit. Rx reflector sub-unit 164 is an example of SR2 114 of FIG. 1, having 8 units.

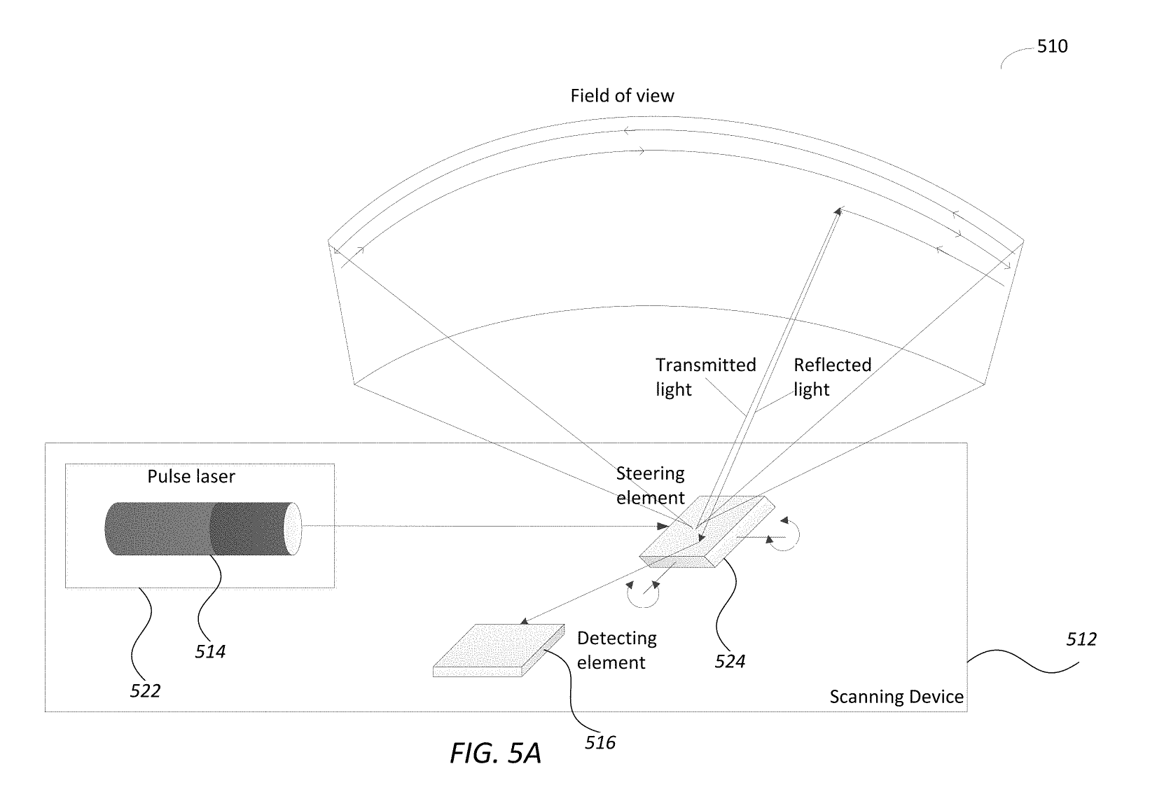

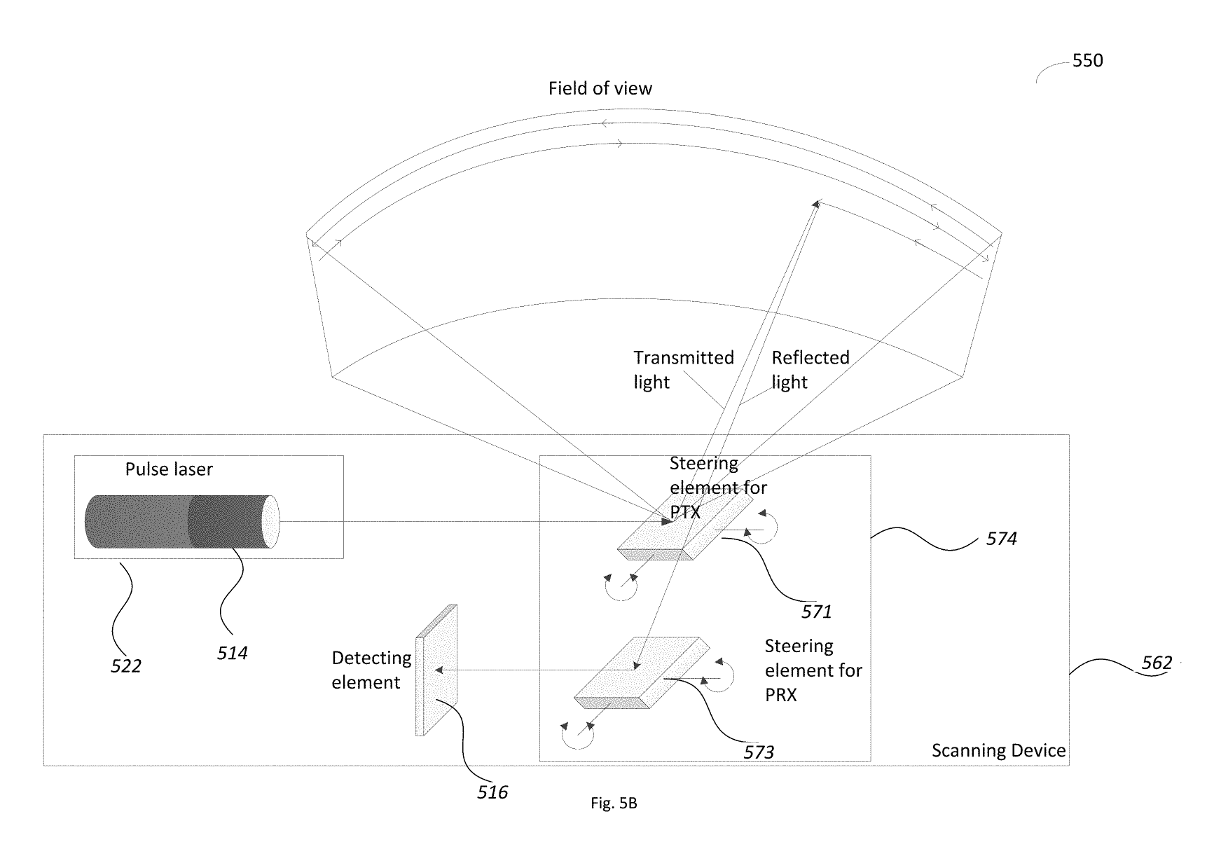

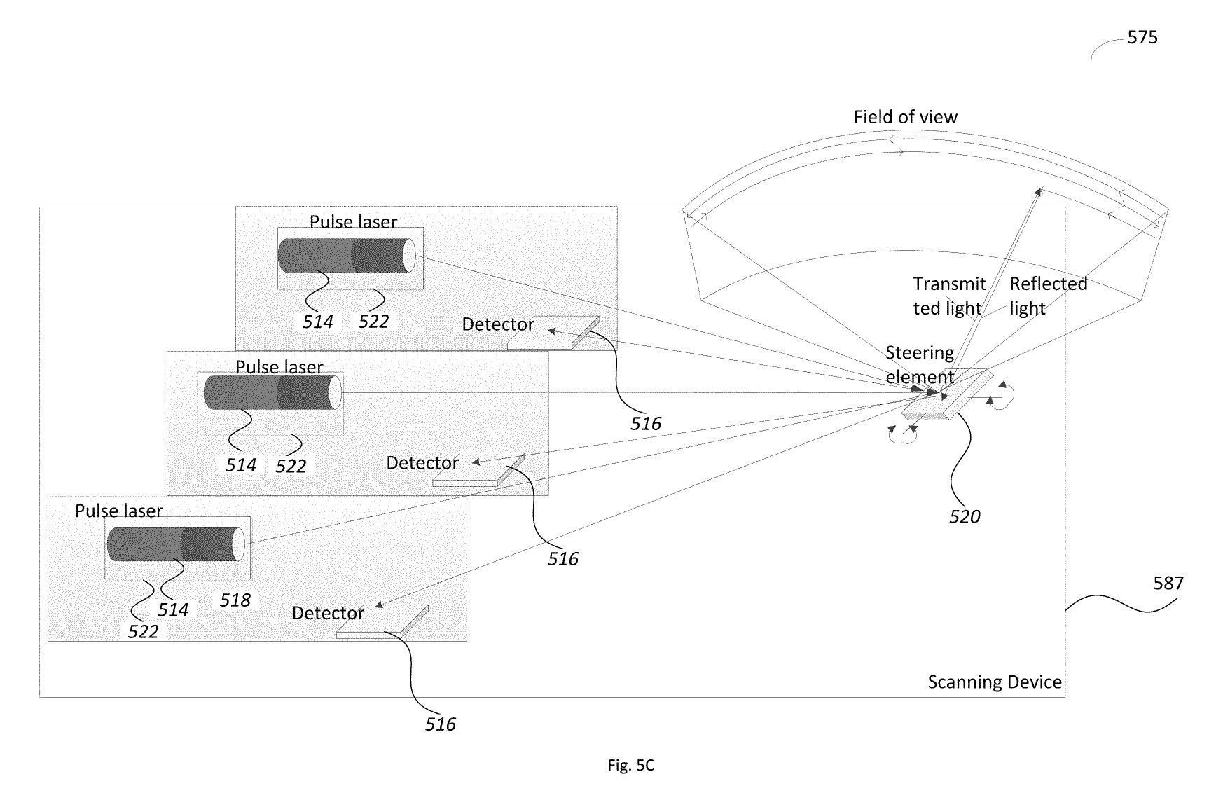

Turning to FIG. 5A, depicted is an example scanning device schematic 510. According to some embodiments, there may be provided a scene scanning device such as scanning device 512 which may be adapted to inspect regions or segments of a scene (shown here is a specific FOV being scanned) using photonic pulses (transmitted light) whose characteristics may be dynamically selected as a function of: (a) optical characteristics of the scene segment being inspected; (b) optical characteristics of scene segments other than the one being inspected; (c) scene elements present or within proximity of the scene segment being inspected; (d) scene elements present or within proximity of scene segments other than the one being inspected; (e) an operational mode of the scanning device; and/or (f) a situational feature/characteristic of a host platform with which the scanning device is operating. The scene scanning device may be adapted to inspect regions or segments of a scene using a set of one or more photonic transmitters 522 (including a light source such as pulse laser 514), receptors including sensors (such as detecting element 516) and/or steering assembly 524; whose configuration and/or arrangement may be dynamically selected as a function of: (a) optical characteristics of the scene segment being inspected; (b) optical characteristics of scene segments other than the one being inspected; (c) scene elements present or within proximity of the scene segment being inspected; (d) scene elements present or within proximity of scene segments other than the one being inspected; (e) an operational mode of the scanning device; and/or (f) a situational characteristic of a host platform with which the scanning device is operating. It is understood that steering assembly 524 may be substantially similar to CR 102 of FIG. 1A. Active scanning device 512 may include: (a) a photonic emitter assembly 522 which produces pulses of inspection photons; (b) a photonic steering assembly 524 that directs the pulses of inspection photons to/from the inspected scene segment; (c) a photonic detector assembly 516 to detect inspection photons reflected back from an object within an inspected scene segment; and (d) a controller to regulate operation of the photonic emitter assembly, the photonic steering assembly and the operation of the photonic detection assembly in a coordinated manner and in accordance with scene segment inspection characteristics of the present invention at least partially received from internal feedback of the scanning device so that the scanning device is a closed loop dynamic scanning device. A closed loop scanning device is characterized by having feedback from at least one of the elements and updating one or more parameter based on the received feedback. A closed loop system may receive feedback and update the systems own operation at least partially based on that feedback. A dynamic system or element is one that may be updated during operation.

According to some embodiments, inspection of a scene segment may include illumination of the scene segment or region with a pulse of photons (transmitted light), which pulse may have known parameters such as pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarization and more. Inspection may also include detecting and characterizing various aspects of reflected inspection photons, which reflected inspection photons are inspection pulse photons (reflected light) reflected back towards the scanning device (or laser reflection) from an illuminated element present within the inspected scene segment (i.e. scene segment element). Characteristics of reflected inspection photons may include photon time of flight (time from emission till detection), instantaneous power (or power signature) at and during return pulse detection, average power across entire return pulse and photon distribution/signal over return pulse period the reflected inspection photons are a function of the inspection photons and the scene elements they are reflected from and so the received reflected signal is analyzed accordingly. In other words, by comparing characteristics of a photonic inspection pulse with characteristics of a corresponding reflected and detected photonic pulse, a distance and possibly a physical characteristic such as reflected intensity of one or more scene elements present in the inspected scene segment may be estimated. By repeating this process across multiple adjacent scene segments, optionally in some pattern such as raster, Lissajous or other patterns, an entire scene may be scanned in order to produce a map of the scene.

Turning to FIG. 5B, depicted is an example bistatic scanning device schematic 550. It is understood that scanning device 562 is substantially similar to scanning device 512. However, scanning device 512 is a monostatic scanning device while scanning device 562 is a bi static scanning device. Accordingly, steering element 574 is comprised of two steering elements: steering element for PTX 571 and steering element for PRX 573. The rest of the discussion relating to scanning device 512 of FIG. 5A is applicable to scanning device 562 FIG. 5B.

Turning to FIG. 5C, depicted is an example scanning device with a plurality of photonic transmitters 522 and a plurality of detectors 516, all having a joint steering element 520. It is understood that scanning device 587 is substantially similar to scanning device 512. However, scanning device 587 is a monostatic scanning device with a plurality of transmitting and receiving elements. The rest of the discussion relating to scanning device 512 of FIG. 5A is applicable to scanning device 587 FIG. 5C.

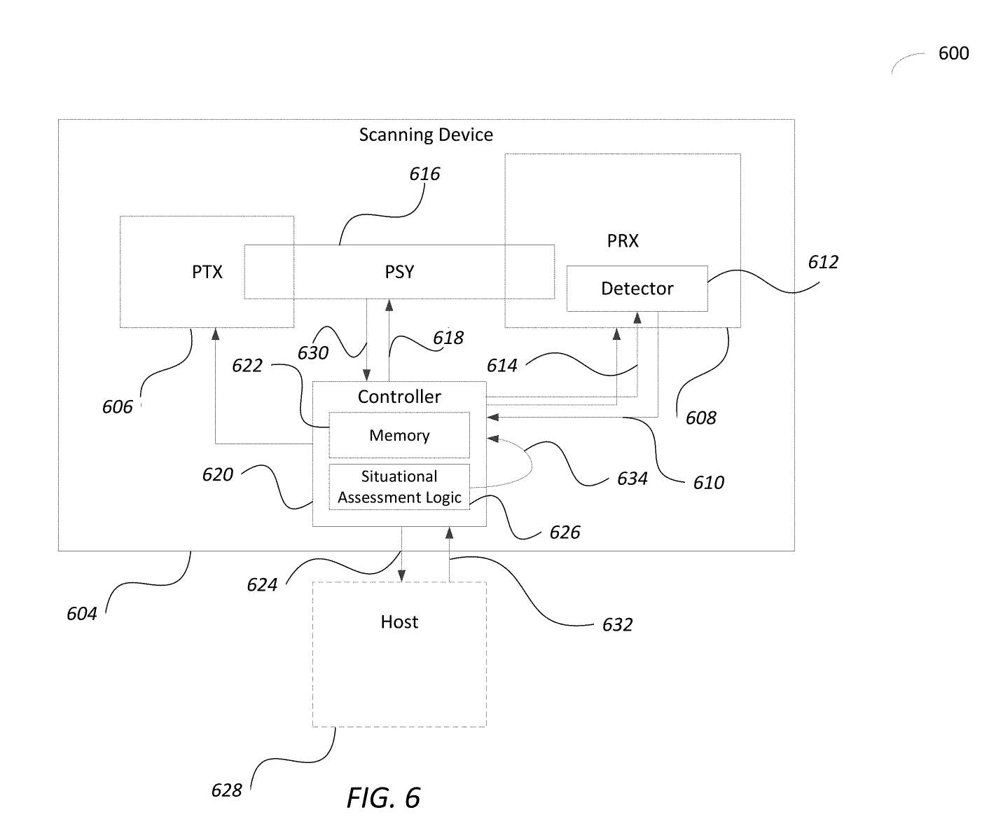

Turning to FIG. 6, depicted is an example scanning system 600 in accordance with some embodiments. Scanning system 600 may be configured to operate in conjunction with a host device 628 which may be a part of system 600 or may be associated with system 600. Scanning system 600 may include a scene scanning device such as scanning device 604 adapted to inspect regions or segments of a scene using photonic pulses whose characteristics may be dynamically selected. Scanning device 604 may include a photonic emitter assembly (PTX) such as PTX 606 to produce pulses of inspection photons. PTX 606 may include a laser or alternative light source. The light source may be a laser such as a solid state laser, a high power laser or otherwise or an alternative light source such as, a LED based light source or otherwise. Scanning device 604 may be an example embodiment for scanning device 612 of FIG. 5A and/or scanning device 562 of FIG. 5B and/or scanning device 587 of FIG. 5C and the discussion of those scanning devices is applicable to scanning device 604.

According to some embodiments, the photon pulses may be characterized by one or more controllable pulse parameters such as: pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarization and more. The inspection photons may be controlled so that they vary in pulse duration, pulse angular dispersion, photon wavelength, instantaneous power, photon density at different distances from the emitter average power, pulse power intensity, pulse width, pulse repetition rate, pulse sequence, pulse duty cycle, wavelength, phase, polarization and more. The photon pulses may vary between each other and the parameters may change during the same signal. The inspection photon pulses may be pseudo random, chirp sequence and/or may be periodical or fixed and/or a combination of these. The inspection photon pulses may be characterized as: sinusoidal, chirp sequences, step functions, pseudo random signals, or linear signals or otherwise.

According to some embodiments, scanning device 604 may include a photonic reception and detection assembly (PRX) such as PRX 608 to receive reflected photons reflected back from an object or scene element and produce detected scene signal 610. PRX 608 may include a detector such as detector 612. Detector 612 may be configured to detect the reflected photons reflected back from an object or scene element and produce detected scene signal 610.

According to some embodiments, detected scene signal 610 may include information such as: time of flight which is indicative of the difference in time between the time a photon was emitted and detected after reflection from an object, reflected intensity, polarization values and more.

According to some embodiments, scanning device 604 may be a monostatic scanning system where PTX 606 and PRX 608 have a joint optical path. Scanning device 604 may include a photonic steering assembly (PSY), such as PSY 616, to direct pulses of inspection photons from PTX 606 in a direction of an inspected scene and to steer reflection photons from the scene back to PRX 608. PTX 616 may also be in charge of positioning the singular scanned pixel window onto/in the direction of detector 612.

According to some embodiments PSY 616 may be a dynamic steering assembly and may be controllable by steering parameters control 618. Example steering parameters may include: scanning method that defines the acquisition pattern and sample size of the scene, power modulation that defines the range accuracy of the acquired scene, correction of axis impairments based on collected feedback and reliability confirmation, definition which sub-sections are CRXR and which are CTXR.

According to some embodiments PSY 616 may include: (a) a Single Dual-Axis MEMS mirror; (b) a dual single axis MEMS mirror; (c) a mirror array where multiple mirrors are synchronized in unison and acting as a single large mirror; (d) a mirror splitted array with separate transmission and reception and/or (e) a combination of these and more.

According to some embodiments, part of the array may be used for the transmission path and the second part of the array may be used for the reception path. The transmission mirrors may be synchronized and the reception mirrors may be synchronized separately from the transmission mirrors. The transmission mirrors and the reception mirrors sub arrays may maintain an angular shift between themselves in order to steer the beam into separate ports, essentially integrating a circulator module.

According to some embodiments, PSY 616 may include one or more PSY state sensors to produce a signal indicating an operational state of PSY 616 for example power information or temperature information, reflector state, reflector actual axis positioning, reflector mechanical state and reflector operative state (transmission state, reception state or idle state) more.

According to some embodiments, PSY 616 may include one or more steerable reflectors, each of which may include a reflective surface associated with an electrically controllable actuator. PSY 616 may include or be otherwise associated with one or more microelectromechanical systems (MEMS) mirror assemblies or an array with a plurality of steerable reflectors. A photonic steering assembly according to refractive embodiments may include one or more reflective materials whose index of refraction may be electrically modulated, either by inducing an electric field around the material or by applying electromechanical vibrations to the material. PSY 606 complex reflector may include two or more CCRs steerable separately or dependent on each other. Furthermore, the complex reflector may include one or more dynamic CCRs which same complex reflector may be controllable to switch between a transmission, reception and/or idle mode. Accordingly control signals to PSY 617 may also control a transmission phase and/or a reception phase; a single phase which transmission and/or reception phase are both derived from, specific phases for each complex reflector, or for each CCR, and mode selection for dynamic reflectors (transmission, reception and/or idle) and/or frequency parameters.

According to some embodiments, scanning device 604 may include a controller, such as controller 620. Controller 604 may receive scene signal 610 from detector 612 and may control PTX 606, PSY 618 PRX 608 including detector 612 based on information stored in the controller memory 622 as well as received scene signal 610 including accumulated information from a plurality of scene signals 610 received over time.

According to some embodiments, controller 620 may process scene signal 610 optionally, with additional information and signals and produce a vision output such as vision signal 624 which may be relayed/transmitted/to an associated host device. Controller 620 may receive detected scene signal 610 from detector 612, optionally scene signal 610 may include time of flight values and intensity values of the received photons. Controller 620 may build up a point cloud or 3D or 2D representation for the FOV by utilizing digital signal processing, image processing and computer vision techniques.

According to some embodiments, controller 620 may include situational assessment logic or circuitry such as situational assessment logic (SAL) 626. SAL 626 may receive detected scene signal 610 from detector 612 as well as information from additional blocks/elements either internal or external to scanning device 104.

According to some embodiments, scene signal 210 can be assessed and calculated according with or without additional feedback signals such as a PSY feedback PTX feedback, PRX feedback and host feedback and information stored in memory 622 to a weighted means of local and global cost functions that determine a work plan such as work plan signal 634 for scanning device 604 (such as: which pixels in the FOV are scanned, at which laser parameters budget, at which detector parameters budget). Accordingly, controller 620 may be a closed loop dynamic controller that receives system feedback and updates the system's operation based on that feedback.

According to some embodiments, SAL 626 may receive one or more feedback signals from PSY 616 via PSY feedback 630. PSY feedback 630 may include instantaneous position of PSY 616 where PSY 616 may include one or more reflecting elements and each reflecting element may contain one or more axis of motion, it is understood that the instantaneous position may be defined or measured in one or more dimensions. Typically, PSY's have an expected position however PSY 616 may produce an internal signal measuring the instantaneous position (meaning, the actual position) then providing such feedback may be utilized by situational assessment logic 626 for calculating drifts and offsets parameters in the PRX and/or for correcting steering parameters control 218 of PSY 616 to correct an offset. Furthermore, PSY feedback 630 may indicate a mechanical failure which may be relayed to host 628 which may either compensate for the mechanical failure or control host 628 to avoid an accident due to the mechanical failure.

According to some embodiments SAL 626 may select and operate array reflectors. SAL 626 may dynamically select a first set of array reflectors to use as part of the PTX, and may select a second set of reflectors to use as part of the PRX.

According to further embodiments, SAL 626 may increase a number of reflectors in the first set to reflectors in or to increase inspection pulse (TX beam) spread. SAL 626 may also decrease a number of reflectors in the second set in order to narrow RX FOV and/or to compensate for background noise or ambient light conditions. Sub control circuits may be included in PSY 616.

According to some embodiments, PSY feedback 630 may include instantaneous scanning speed of PSY 616. PSY 616 may produce an internal signal measuring the instantaneous speed (meaning, the actual speed and not the estimated or anticipated speed) then providing such feedback may be utilized by situational assessment logic 626 for calculating drifts and offsets parameters in the PRX and/or for correcting steering parameters control 618 of PSY 616 to correct an offset. The frequency may be for a single CR or for a CCR and more.

According to some embodiments, PSY feedback 630 may include instantaneous scanning frequency of PSY 616. PSY 616 may produce an internal signal measuring the instantaneous frequency (meaning, the actual frequency and not the estimated or anticipated frequency) then providing such feedback may be utilized by situational assessment logic 626 for calculating drifts and offsets parameters in the PRX and/or for correcting steering parameters control 618 of PSY 616 to correct an offset. The instantaneous frequency may be relative to one or more axis.

According to some embodiments, PSY feedback 630 may include mechanical overshoot of PSY 616, which represents a mechanical de-calibration error from the expected position of the PSY in one or more axis. PSY 616 may produce an internal signal measuring the mechanical overshoot then providing such feedback may be utilized by situational assessment logic 626 for calculating drifts and offsets parameters in the PRX and/l or for correcting steering parameters control 618 of PSY 616 to correct an offset. PSY feedback may also be utilized in order to correct steering parameters in case of vibrations induced by the Lidar system or by external factors such as vehicle engine vibrations or road induces shocks.

According to some embodiments, PSY feedback 630 may be utilized to correct steering parameters 618 to correct the scanning trajectory and linearize it. The raw scanning pattern may typically be non-linear to begin with and contains artifacts resulting from fabrication variations and the physics of the MEMS mirror or reflective elements. Mechanical impairments may be static, for example a variation in the curvature of the mirror, and dynamic, for example mirror warp/twist at the scanning edge of motion correction of the steering parameters to compensate for these non-linearizing elements may be utilized to linearize the PSY scanning trajectory.

According to some embodiments, SAL 626 may receive one or more signals from memory 622. Information received from the memory may include laser power budget (defined by eye safety limitations, thermal limitations reliability limitation or otherwise); electrical operational parameters such as current and peak voltages; calibration data such as expected PSY scanning speed, expected PSY scanning frequency, expected PSY scanning position and more.

According to some embodiments, steering parameters of PSY 616, detector parameters of detector 612 and/or pulse parameters of PTX 606 may be updated based on the calculated/determined work plan 634. Work plan 634 may be tracked and determined at specific time intervals and with increasing level of accuracy and refinement of feedback signals (such as 630 and 632).

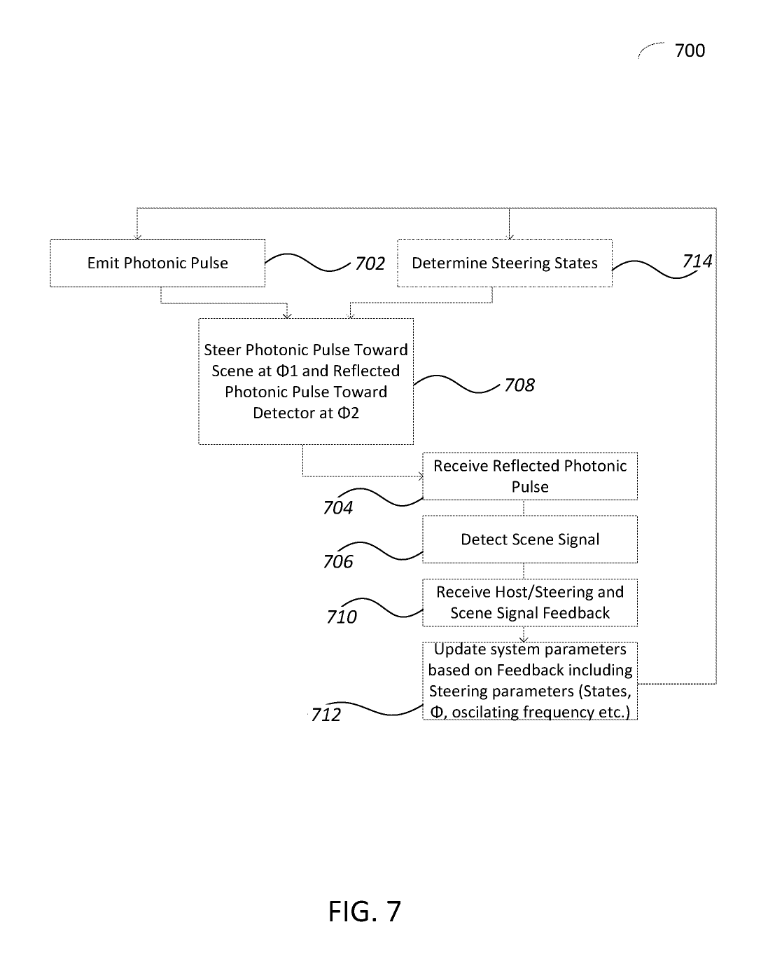

Turning to FIG. 7 shown is a flow chart associated with a method of scanning a scene 700. A photonic pulse may be emitted (702) and a reflected pulse may be received (704) and detected (706). The pulses may be steered in a joint path, the photonic pulse steered toward the scene, the pulse characterized by a first phase and the reflected pulse from the scene toward the detector, the reflected pulse characterized by a second phase (708). Based on system feedback such as the detected signal, host information, steering feedback and more (710) the steering parameters may be updated including correcting the first or second phase, oscillating frequency and more (712).

According to some embodiments, a steering state may be programmable/adjustable in which case the initial state is determined and may be updated based on the feedbacks (714).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A light detection and ranging (Lidar) device comprising:
a photonic pulse emitter assembly comprising one or more photonic emitters to generate and focus a photonic inspection pulse towards a photonic transmission (TX) path of said device;
a photonic detection assembly comprising one or more photo sensors to receive and sense photons of a reflected photonic inspection pulses received through a receive (RX) path of said device;
a photonic steering assembly located along both the TX and the RX paths and comprising a Complex Reflector (CR) made of an array of steerable reflectors, wherein a first set of steerable reflectors are part of the TX path and a second set of steerable reflectors are part of the RX path.

2. The Lidar according to claim 1, wherein said first set of steerable reflectors direct a photonic inspection pulse from said photonic pulse emitter assembly towards a given segment of a scene to be inspected.

3. The Lidar according to claim 2, wherein said second set of steerable reflectors direct a photonic inspection pulse reflection, reflected off of a surface of an element present in the given segment of the scene, towards said photonic detection assembly.

4. The Lidar device according to claim 1, wherein said array of steerable reflectors are dynamic steerable reflectors.

5. The Lidar device according to claim 4, wherein said reflectors are dynamically steered to compensate for mechanical impairments and drifts.

6. The Lidar device according to claim 4, wherein said dynamic steerable reflectors have a controllable state, wherein said state is selected from the list consisting of: a transmission state, a reception state and an idle state.

7. The Lidar device according to claim 1, wherein said first set of steerable reflectors are mechanically coupled to each other and said second set of steerable reflectors are mechanically coupled to each other.

8. The Lidar device according to claim 1, wherein said first set of steerable reflectors are electronically coupled to each other and said second set of steerable reflectors are electronically coupled to each other.

9. The Lidar device according to claim 1, wherein the dynamic steerable reflectors are individually steerable.

10. The Lidar device according to claim 1, wherein said first set of steerable reflectors have a first phase and are substantially synchronized and said second set of steerable reflectors have a second phase and are substantially synchronized.

11. The Lidar device according to claim 10, wherein said first phase and said second phase have a substantially fixed difference between them.

12. The Lidar device according to claim 10, wherein said first set of steerable reflectors oscillate together at a first frequency and said second set of steerable reflectors oscillate together at a second frequency wherein said first and second frequency have a substantially fixed phase shift between them.

13. The Lidar device of claim 6, wherein increasing a number of dynamic steerable reflectors in a transmission state increases a transmission beam spread.

14. The Lidar device of claim 13, wherein decreasing a number of dynamic steerable reflectors in a reception state decreases reception field of view and is configured to compensate for ambient light conditions.

15. The Lidar device of claim 6, wherein dynamic steerable reflectors in an idle state provide isolation between dynamic steerable reflectors in a transmission state and a reception state.

16. The Lidar device of claim 1, wherein said first set of steerable reflectors are surrounded by said second set of steerable reflectors.

17. The Lidar device of claim 1, wherein said second set of steerable reflectors are surrounded by said first set of steerable reflectors.

18. A method of scanning a scene comprising:
emitting a photonic pulse towards a photonic transmission (TX) path;
receiving reflected photonic pulses received through a receive (RX) path;
detecting with a detector a scene signal based on said reflected photonic inspection pulses; and
complexly steering the photonic pulse towards a scene and the reflected photonic pulses from a scene to the detector; by reflecting at a first phase said photonic pulse and receiving at a second phase said reflected pulse, wherein the difference between said first and second phase is dependent on the time it takes the photonic pulse to be reflected and return.

19. A vehicle comprising:
a scanning device to produce a detected scene signal, said scanning device including: a photonic pulse emitter assembly comprising one or more photonic emitters to generate and focus a photonic inspection pulse towards a photonic transmission (TX) path of said device;
a photonic detection assembly comprising one or more photo sensors to receive and sense photons of a reflected photonic inspection pulses received through a receive (RX) path of said device;
a photonic steering assembly located along both the TX and the RX paths and comprising a Complex Reflector (CR) made of an array of steerable reflectors, wherein a first set of steerable reflectors are part of the TX path and a second set of steerable reflectors are part of the RX path; and
a host controller to receive said detected scene signal and control said host device at least partially based on said detected scene signal.
